(19) United States
(12) Patent Application Publication
(10) Pub. No.: US 2016/0050698 A1
(43) Pub. Date: Feb. 18, 2016

(54) System and Method for Obtaining and Using Device-to-Device Frequency-Related Capability and Configuration Preferences

(71) Applicant: Telefonaktiebolaget L M Ericsson (publ), Stockholm (SE)

(72) Inventor: Iana Siomina, TABY (SE)

(21) Appl. No.: 14/436,432

(22) PCT Filed: Mar. 27, 2015
(86) PCT No.: PCT/SE2015/050371

§ 371 Date: Apr. 16, 2015

Related U.S. Application Data
(60) Provisional application No. 61/973,610, filed on Apr. 1, 2014.

(51) Int. Cl. H04W 76/02; H04W 8/00; H04W 72/04

(52) U.S. Cl. CPC H04W 76/023; H04W 72/0406; H04W 8/005

(57) ABSTRACT

The disclosure relates to a method (10) for providing device-to-device, D2D, operation performed in a first D2D capable wireless device (110A). The method (10) comprises signaling (11), to a first node (115A; 110B), at least one of: a D2D frequency-related capability and a D2D configuration preference of the first D2D capable wireless device (110A); receiving (12), from the first node (115A; 110B), a message based on at least one of the D2D frequency-related capability and the D2D configuration preference, and configuring (13), based on the message received from the first node (115A; 110B), the first D2D-capable wireless device (110A) to operate according to at least one of the D2D frequency-related capability and the D2D configuration preference. A corresponding D2D capable wireless device (110A) is also provided, and a method (20) in a node (115A; 110B), a node (115A; 110B), computer programs and computer program products.

### TECHNICAL FIELD

Particular embodiments relate generally to wireless communications and more particularly to a system and method for obtaining and using device-to-device frequency-related capability and configuration preferences.

### BACKGROUND

In a wireless network, a wireless device may communicate with one or more radio access nodes to send and/or receive information, such as voice traffic, data traffic, control signals, and so on. Wireless devices that are in proximity to each other may be able to communicate directly with one another using device-to-device communication methods. For instance, a network node assist in a first wireless device discovering another wireless device residing in its proximity and to which a so-called direct mode data path or locally routed data path could be established. The direct mode as well as the locally routed data path entails several advantages such as reducing latency and enabling spatial reuse of time and/or frequency resources.

In the D2D communication, e.g. in the direct mode, the wireless device still needs to maintain a communication link to the network node, and the network node should be able to control D2D links e.g. for interference coordination and power control of the links. The maintaining of two links by the wireless device and the at least some control or involvement by the network node requires the signaling to be as efficient as possible, e.g. to entail as little overhead as possible. It would be desirable to enable D2D communication in as efficient manner as possible, e.g. the setting up of such communication.

### SUMMARY

According to the present disclosure, in order to achieve the object above it is suggested to signal at least one of a D2D frequency-related capability and a D2D configuration preference of a first D2D capable wireless device to a first node. The first node might either be a network node for coordinating the D2D operation in the wireless communication network or another D2D capable device.

In particular example implementations, the proposed solutions may provide a method for providing device-to-device communications using device-to-device frequency-related capability and configuration preferences for wireless devices. In one example embodiment, the method may be implemented by a first D2D capable wireless device and may include:
Signaling a device-to-device frequency-related capability and/or its D2D configuration preference to a first node,
Receiving a message or indication from the first node based on the capability and/or D2D configuration preference;
Configuring the first D2D-capable wireless device to operate with at least one of the D2D frequency-related configurations supported/preferred by the first wireless device;
Performing at least one D2D operation while being configured with the at least one of the D2D frequency-related configurations;
Optionally, the signaled capability comprises one or more D2D frequency-related configurations supported by the first D2D-capable wireless device;
Optionally, the first node may include a network node;
Optionally, the first node may include a second D2D-capable wireless device;

In another example embodiment, the method may be implemented by a network node and may include:
Receiving D2D frequency-related capability and/or D2D configuration preference from a first D2D-capable wireless device;
Using the obtained capability/preferences for one or more operational tasks.

Other implementations may include a wireless communication device and/or access node configured to implement the described method, or a wireless communication system in which a wireless communication device and/or access node implement the described method.

Some embodiments of the disclosure may provide one or more technical advantages. For example, certain embodiments may provide off-loading of the cellular network, faster communication, increased awareness of surrounding wireless devices of interest (e.g., running the same application), higher-quality links due to a shorter distance, etc. Some appealing applications of D2D communications are video streaming, online gaming, media downloading, peer-to-peer (P2P), file sharing, etc.

Some embodiments may benefit from some, none, or all of these advantages. Other technical advantages may be readily ascertained by one of ordinary skill in the art.

An objective of the present disclosure is to provide improvements relating to D2D communication.

The objective is according to an aspect achieved by a method for providing device-to-device, D2D, operation performed in a first D2D capable wireless device. The method comprises: signaling, to a first node, at least one of: a D2D frequency-related capability and a D2D configuration preference of the first D2D capable wireless device; receiving, from the first node, a message based on at least one of the D2D frequency-related capability and the D2D configuration preference, and configuring, based on the message received from the first node, the first D2D-capable wireless device to operate according to at least one of the D2D frequency-related capability and the D2D configuration preference.

The method provides several advantages, e.g. it enables a correct, and even optimized, D2D configuration to be used in an efficient way. For instance, the D2D capable wireless device may be configured for D2D operation on a frequency where the D2D operation is supported, or where the expected performance of the D2D operation is the best. The first node configuring the D2D capable wireless device is made aware of the configurations and/or preferences thereof.

The objective is according to an aspect achieved by a computer program for a D2D capable wireless device. The computer comprises computer program code, which, when executed on at least one processor on the D2D capable wireless device, causes the D2D capable wireless device, to perform the method as above.

The objective is according to an aspect achieved by a computer program product comprising a computer program as above and a computer readable means on which the computer program is stored.

The objective is according to an aspect achieved by a device-to-device, D2D, capable wireless device for providing D2D operation. The D2D capable wireless device is configured to signal, to a first node, at least one of: a D2D frequency-related capability and a D2D configuration preference of the first D2D capable wireless device, and; receive, from the first node, a message based on at least one of the D2D frequency-related capability and the D2D configuration preference, and configure, based on the message received from the first node, the first D2D-capable wireless device to operate according to at least one of the D2D frequency-related capability and the D2D configuration preference.

The objective is according to an aspect achieved by a method for providing device-to-device, D2D, operation performed in a node. The method comprises: obtaining at least one of: a D2D frequency-related capability and a D2D configuration preference of a first D2D capable wireless device; and using the obtained D2D frequency-related capability and/or the D2D configuration preference of the first D2D capable wireless device for one or more operational tasks.

The objective is according to an aspect achieved by a computer program for a node. The computer program comprises computer program code, which, when executed on at least one processor on the node, causes the node to perform the method as above.

The objective is according to an aspect achieved by a computer program product comprising a computer program as above and a computer readable means on which the computer program is stored.

The objective is according to an aspect achieved by a node for providing device-to-device, D2D, operation. The node is configured to: obtain at least one of: a D2D frequency-related capability and a D2D configuration preference of a first D2D capable wireless device; and use the obtained D2D frequency-related capability and/or the D2D configuration preference of the first D2D capable wireless device for one or more operational tasks.

Further features and advantages of the present disclosure will become clear upon reading the following description and the accompanying drawings.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating an embodiment of a network;

FIG. 2 is a block diagram illustrating certain embodiments of a wireless device;

FIG. 3 is a block diagram illustrating certain embodiments of a radio network node;

FIG. 4 is a block diagram illustrating certain embodiments of a core network node;

FIG. 5 is a block diagram illustrating certain embodiments providing a default data path scenario for communication between two wireless devices;

FIG. 6 is a block diagram illustrating certain embodiments providing a direct mode data path for communication between two wireless devices;

FIG. 7 is a block diagram illustrating certain embodiments providing a “locally-routed” data path for communication between two wireless devices;

FIG. 8 is a block diagram illustrating certain embodiments of a device-to-device system architecture using device-to-device frequency-related capability and configuration preferences for device-to-device communications; and

FIG. 9 is a flowchart illustrating certain embodiments of a method using device-to-device frequency-related capability and configuration preferences for device-to-device communications.

FIG. 10 is a flow chart illustrating a method in a device-to-device capable wireless device.

FIG. 11 is a flow chart illustrating a method in a node.

### DETAILED DESCRIPTION

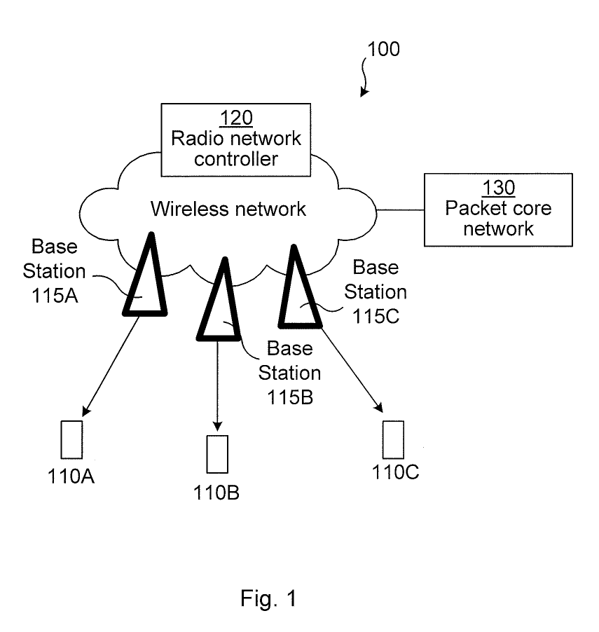

Particular embodiments are described in FIGS. 1-9 of the drawings, like numerals being used for like and corresponding parts of the various drawings.

FIG. 1 is a block diagram illustrating embodiments of a radio network 100 that includes one or more wireless devices 110, radio network nodes 115, radio network controller 120, and core network nodes 130. A wireless device 110 may communicate with a radio network node 115 over a wireless interface. For example, wireless device 110 may transmit wireless signals to radio network node 115 and/or receive wireless signals from radio network node 115. The wireless signals may contain voice traffic, data traffic, control signals, and/or any other suitable information.

Radio network node 115 may interface with radio network controller 120. Radio network controller 120 may control radio network node 115 and may provide certain radio resource management functions, mobility management functions, and/or other suitable functions. Radio network controller 120 may interface with core network node 130. In certain embodiments, radio network controller 120 may interface with core network node 130 via an interconnecting network. The interconnecting network may refer to any interconnecting system capable of transmitting audio, video, signals, data, messages, or any combination of the preceding. The interconnecting network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

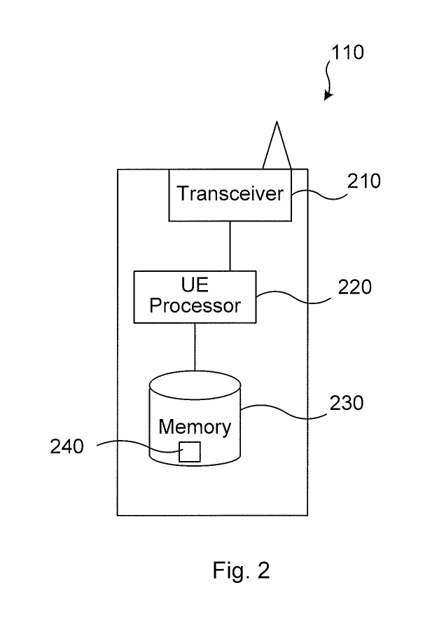

In some embodiments, core network node 130 may manage the establishment of communication sessions and various other functionalities for wireless device 110. Wireless device 110 may exchange certain signals with core network node 130 using the non-access stratum layer. In non-access stratum signaling, signals between wireless device 110 and core network node 130 may be transparently passed through the radio access network. Example embodiments of wireless device 110, radio network node 115, and a network node (such as radio network controller 120 or core network node 130) are described with respect to FIGS. 2, 3, and 4 respectively.

FIG. 2 is a block diagram illustrating certain embodiments of a wireless device 110. Examples of wireless device no include a mobile phone, a smart phone, a PDA (Personal Digital Assistant), a portable computer (e.g., laptop, tablet), a sensor, a modem, a machine type (MTC) device/machine to machine (M2M) device, laptop embedded equipment (LEE), laptop mounted equipment (LME), USB dongles, a device-to-device capable device, or another device that can provide wireless communication. A wireless device no may also be referred to as user equipment (UE), a station (STA), a device, or a terminal in some embodiments. Wireless device no includes transceiver 210, processor 220, and memory 230. In some embodiments, transceiver 210 facilitates transmitting wireless signals to and receiving wireless signals from radio network node 120 (e.g., via an antenna), processor 220 executes instructions to provide some or all of the functionality described above as being provided by wireless device 110, and memory 230 stores the instructions executed by processor 220.

Processor 220 may include any suitable combination of hardware and software implemented in one or more modules 240 to execute instructions and manipulate data to perform some or all of the described functions of wireless device no. In some embodiments, processor 220 may include, for example, one or more computers, one or more central processing units (CPUs), one or more microprocessors, one or more applications, and/or other logic.

Memory 230 is generally operable to store instructions, such as a computer program, software, an application including one or more of logic, rules, algorithms, code, tables, etc. and/or other instructions capable of being executed by a processor. Examples of memory 230 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

Other embodiments of wireless device no may include additional components beyond those shown in FIG. 2 that may be responsible for providing certain aspects of the wireless device's functionality, including any of the functionality described above and/or any additional functionality (including any functionality necessary to support the solution described above).

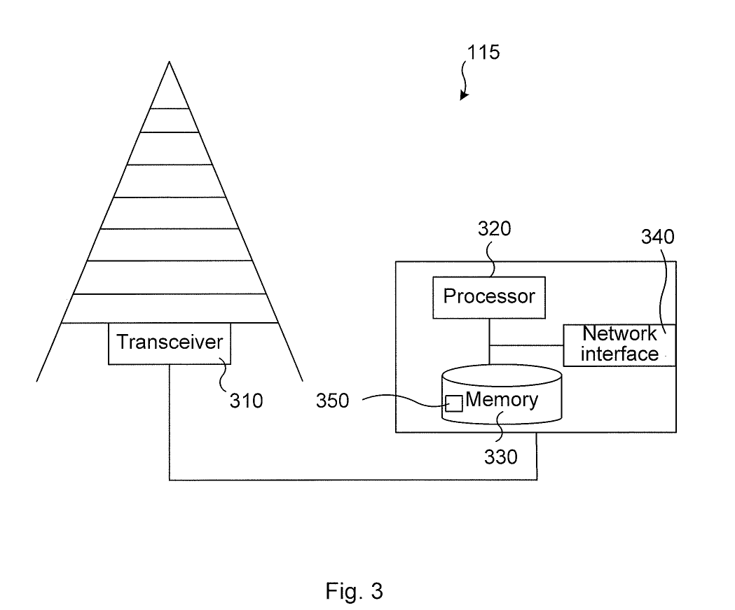

FIG. 3 is a block diagram illustrating certain embodiments of a radio network node 115. Examples of radio network node 115 include an eNodeB, a node B, a base station, a wireless access point (e.g., a Wi-Fi access point), a low power node, a base transceiver station (BTS), transmission points, transmission nodes, remote RF unit (RRU), remote radio head (RRH), etc. Radio network nodes 115 may be deployed throughout network 100 as a homogenous deployment, heterogeneous deployment, or mixed deployment. A homogeneous deployment may generally describe a deployment made up of the same (or similar) type of radio network nodes 115 and/or similar coverage and cell sizes and inter-site distances. A heterogeneous deployment may generally describe deployments using a variety of types of radio network nodes 115 having different cell sizes, transmit powers, capacities, and inter-site distances. For example, a heterogeneous deployment may include a plurality of low-power nodes placed throughout a macro-cell layout. Mixed deployments may include a mix of homogenous portions and heterogeneous portions.

Radio network node 115 may include one or more of transceiver 310, processor 320, memory 330, and network interface 340. In some embodiments, transceiver 310 facilitates transmitting wireless signals to and receiving wireless signals from wireless device 110 (e.g., via an antenna), processor 320 executes instructions to provide some or all of the functionality described above as being provided by a radio network node 115, memory 330 stores the instructions executed by processor 320, and network interface 340 communicates signals to backend network components, such as a gateway, switch, router, Internet, Public Switched Telephone Network (PSTN), core network nodes 130, radio network controllers 120, etc.

Processor 320 may include any suitable combination of hardware and software implemented in one or more modules 350 to execute instructions and manipulate data to perform some or all of the described functions of radio network node 115. In some embodiments, processor 320 may include, for example, one or more computers, one or more central processing units (CPUs), one or more microprocessors, one or more applications, and/or other logic.

Memory 330 is generally operable to store instructions, such as a computer program, software, an application including one or more of logic, rules, algorithms, code, tables, etc. and/or other instructions capable of being executed by a processor. Examples of memory 330 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, network interface 340 is communicatively coupled to processor 320 and may refer to any suitable device operable to receive input for radio network node 115, send output from radio network node 115, perform suitable processing of the input or output or both, communicate to other devices, or any combination of the preceding. Network interface 340 may include appropriate hardware (e.g., port, modem, network interface card, etc.) and software, including protocol conversion and data processing capabilities, to communicate through a network.

Other embodiments of radio network node 115 may include additional components beyond those shown in FIG. 3 that may be responsible for providing certain aspects of the radio network node's functionality, including any of the functionality described above and/or any additional functionality (including any functionality necessary to support the solution described above). The various different types of radio network nodes may include components having the same physical hardware but configured (e.g., via programming) to support different radio access technologies, or may represent partly or entirely different physical components.

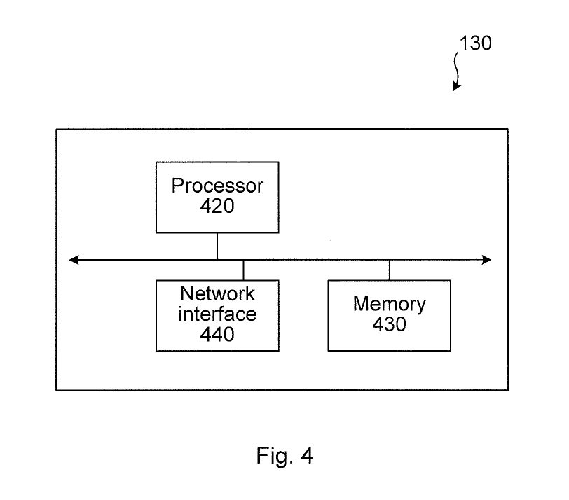

FIG. 4 is a block diagram illustrating certain embodiments of a radio network controller 120 or core network node 130. Examples of network nodes can include a mobile switching center (MSC), a serving GPRS support node (SGSN), a mobility management entity (MME), a radio network controller (RNC), a base station controller (BSC), and so on. The network node includes processor 420, memory 430, and network interface 440. In some embodiments, processor 420 executes instructions to provide some or all of the functionality described above as being provided by the network node, memory 431 stores the instructions executed by processor 420, and network interface 940 communicates signals to a suitable node, such as a gateway, switch, router, Internet, Public Switched Telephone Network (PSTN), radio network nodes 115, radio network controllers 120, core network nodes 130, etc.

Processor 42o may include any suitable combination of hardware and software implemented in one or more modules to execute instructions and manipulate data to perform some or all of the described functions of the network node. In some embodiments, processor 420 may include, for example, one or more computers, one or more central processing units (CPUs), one or more microprocessors, one or more applications, and/or other logic.

Memory 430 is generally operable to store instructions, such as a computer program, software, an application including one or more of logic, rules, algorithms, code, tables, etc. and/or other instructions capable of being executed by a processor. Examples of memory 430 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, network interface 440 is communicatively coupled to processor 420 and may refer to any suitable device operable to receive input for the network node, send output from the network node, perform suitable processing of the input or output or both, communicate to other devices, or any combination of the preceding. Network interface 440 may include appropriate hardware (e.g., port, modem, network interface card, etc.) and software, including protocol conversion and data processing capabilities, to communicate through a network.

Other embodiments of the network node may include additional components beyond those shown in FIG. 4 that may be responsible for providing certain aspects of the network node's functionality, including any of the functionality described above and/or any additional functionality (including any functionality necessary to support the solution described above).

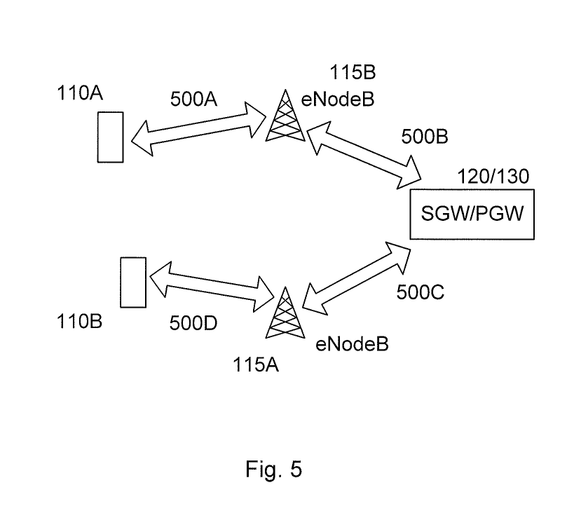

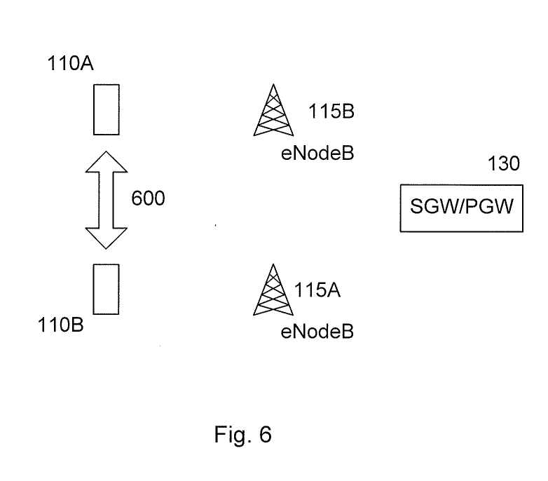

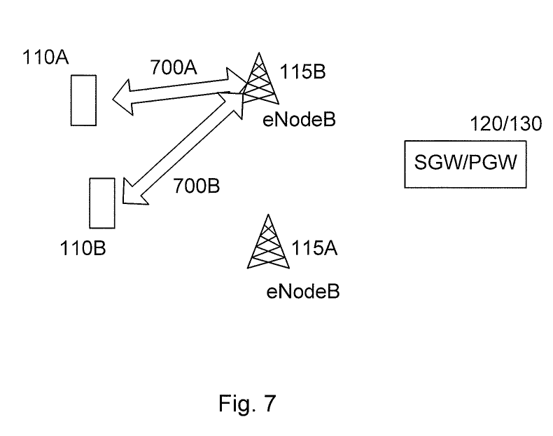

FIG. 5 is a block diagram illustrating certain embodiments providing a default data path 500 scenario for communication between two wireless devices. As depicted, communications between wireless devices 110A-B are communicated through network nodes 115 (115A, 115B) and network node 120 along default path 500A-D. However, wireless devices 110 that are within proximity to each other may be able to use device to device (D2D) communication techniques to communicate more directly with one another. For example, FIG. 6 is a block diagram illustrating certain embodiments providing a direct mode data path 600 for communication between two wireless devices. As another example, FIG. 7 is a block diagram illustrating certain embodiments providing a locally-routed data path 700A-B for communication between two wireless devices. Current D2D communication solutions, however, do not allow or use the signaling of the D2D frequency-related capability by a wireless device and/or a preferred D2D configuration of a wireless device during the provision of such services.

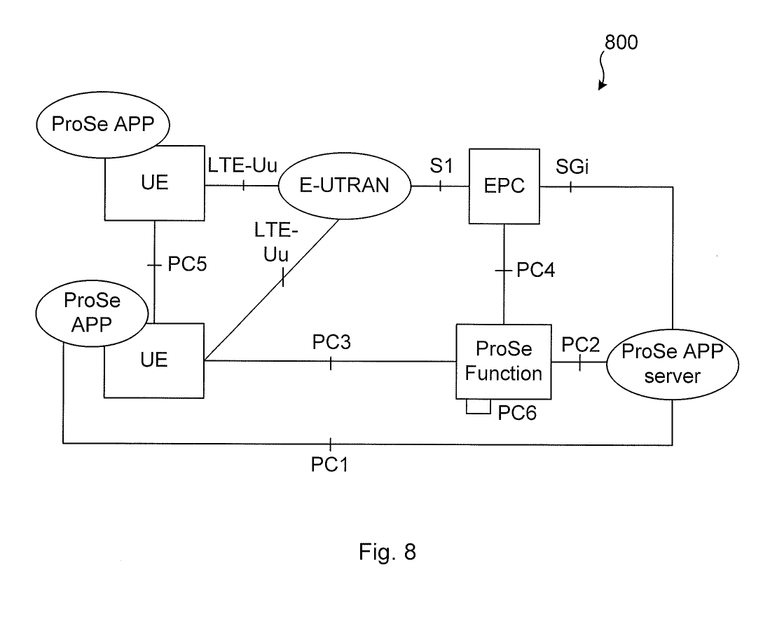

FIG. 8 is a block diagram illustrating certain embodiments of a device-to-device system architecture 800 using device-to-device frequency-related capability and configuration preferences for device-to-device communications. In certain embodiments, a wireless device 110 have may have device-to-device (D2D) capability. Specifically, wireless device 110 may comprise any entity capable of at least receiving or transmitting radio signals on a direct radio link, i.e., between this entity and another D2D capable entity. A D2D-capable device may also be comprised in a cellular UE, PDA, a wireless device, laptop, mobile, sensor, relay, D2D relay, or even a small base station employing a UE-like interface, etc. A D2D-capable is able to support at least one D2D operation. Thus, wireless device 110 may also be called user equipment (UE), D2D user equipment (D2D UE), D2D device, D2D-capable UE, or any other suitable term. In some examples, the terms ‘D2D’ and ‘proximity service’ (ProSe) may be used interchangeably.

In certain embodiments, a D2D operation may comprise any action or activity related to D2D, e.g., transmitting or receiving a signal/channel type for D2D purpose, transmitting or receiving data by means of D2D communication, transmitting or receiving control or assistance data for D2D purpose, transmitting or receiving a request for control or assistance data for D2D, selecting a D2D operation mode, initiating/starting D2D operation, switching to D2D operation mode from a cellular operation mode, configuring receiver or transmitter with one or more parameters for D2D. D2D operation may be for a commercial purpose or to support public safety, using the data related to D2D. D2D operation may or may not be specific to a certain D2D service.

A D2D transmission may be any transmission by a D2D device. Some examples of D2D transmission are physical signals or physical channels, dedicated or common/shared, e.g., reference signal, synchronization signal, control channel, data channel, broadcast channel, paging channel, etc. A D2D transmission on a direct radio link is intended for receiving by another D2D device. A D2D transmission may be a unicast, groupcast, or broadcast transmission.

Network node 115 may be considered a coordinating node. In particular embodiments, the network node 115 schedules, decides, at least in part, or selects time-frequency resources to be used for at least one of: cellular transmissions and D2D transmissions. The coordinating node may also provide the scheduling information to another node such as another D2D device, a cluster head, a radio network node such as eNodeB, or a network node (e.g. a core network node). The coordinating node may communicate with a radio network node.

Although at least some of the embodiments are described for D2D transmissions in the uplink (UL) spectrum (Frequency Division Duplexing, FDD) or UL resources (Time Division Duplexing, TDD), the embodiments are not limited to the usage of UL radio resources, neither to licensed or unlicensed spectrum, or any specific spectrum at all. A cellular network may comprise e.g. a Long Term Evolution (LTE) network (FDD or TDD), Universal Terrestrial Radio Access (UTRA) network, Code division multiple access (CDMA) network, Worldwide Interoperability for Microwave Access (WiMAX), Global System for Mobile Communications (GSM) network, any network employing any one or more radio access technologies (RATs) for cellular operation. The description herein is given for LTE, but it is not limited to the LTE RAT. RAT may include, for example, LTE, GSM, CDMA, Wideband CDMA (WCDMA), WiFi, wireless local area network (WLAN), WiMAX, etc.

In certain embodiments, network node 115 may be a radio network node or another network node. Some examples of the radio network node are a radio base station, a relay node, an access point, a cluster head, RNC, etc. The radio network node is comprised in a wireless communication network and may also support cellular operation. Some examples of a network node which is not a radio network node: a core network node, MME, a node controlling at least in part mobility of a wireless device, SON node, O&M node, positioning node, a server, an application server, a D2D server (which may be capable of some but not all D2D-related features), a node comprising a ProSe function, a ProSe server, an external node, or a node comprised in another network.

The term ‘D2D frequency-related capability’ used herein may refer to the UE's ability to support a D2D operation with one or more frequency-related configurations such as:
One or more specific carrier frequencies/bands/RATs,
Bandwidth (e.g., transmission and/or reception bandwidth) or bandwidth combinations on a frequency carrier,
Bandwidth (e.g., transmission and/or reception bandwidth) or bandwidth combinations over two or more carriers,
Maximum number of parallel D2D sessions or connections per carrier/band/RAT,
Ability to support D2D operation on serving carrier(s) only,
Ability to support D2D operation on a non-serving carrier (i.e., inter-frequency or inter-RAT),
Ability to perform one or more D2D operations on a non-serving carrier or in a non-serving RAT in a specific way (e.g., without measurement gaps or without interruptions caused on the serving cell),
Certain duplex configuration (e.g., full duplex, half duplex, or HD-FDD),
A configuration enabling a certain capacity (e.g., a certain bitrate or throughput for D2D),
Spectrum type (e.g., for DL or UL operation, licensed or unlicensed),
Contiguous or non-contiguous transmissions/reception in the frequency domain,
Multi-carrier D2D operation (simultaneous D2D operation over two or more carriers),
Multiplexing in frequency domain of signals/channels related to D2D operation with other types of signals/channels (e.g., for cellular operation) on the same carrier frequency.

Some of the above capabilities, except at least one, may be also pre-defined for D2D.

The term ‘D2D configuration preference’ may comprise one or more configurations preferred by the UE for D2D operation, e.g.:
One or more specific carrier frequencies/bands/RATs,
Bandwidth (e.g., transmission and/or reception bandwidth) or bandwidth combinations on a frequency carrier,
Bandwidth (e.g., transmission and/or reception bandwidth) or bandwidth combinations over two or more carriers,
Certain time and/or frequency resources (e.g., time slots, subframes, part of the bandwidth, resource blocks, resources according to a pattern, etc.),
Communication range for D2D (e.g., a distance related measure which may be in meters, in dBm for a received signal strength or pathloss, in time units for RTT or TA or propagation delay),
D2D operation on serving carrier(s) only,
D2D operation on a non-serving carrier (i.e., inter-frequency or inter-RAT),
Certain duplex configuration (e.g., full duplex, half duplex, or HD-FDD),
A configuration enabling a certain capacity (e.g., a certain bitrate or throughput for D2D),
Target QoS for D2D operation (e.g., target bitrate, max. error rate, max.
probability of blocking by other UEs, min. signal strength or quality, detection probability, min. RRM requirement, min RF requirement, etc.),
Spectrum type (e.g., for DL or UL operation, licensed or unlicensed),
Contiguous or non-contiguous transmissions/reception in the frequency domain,
Multi-carrier D2D operation (simultaneous D2D operation over two or more carriers),
Multiplexing in frequency domain of signals/channels related to D2D operation with other types of signals/channels (e.g., for cellular operation).

The embodiments described herein may be combined with each other in any way.

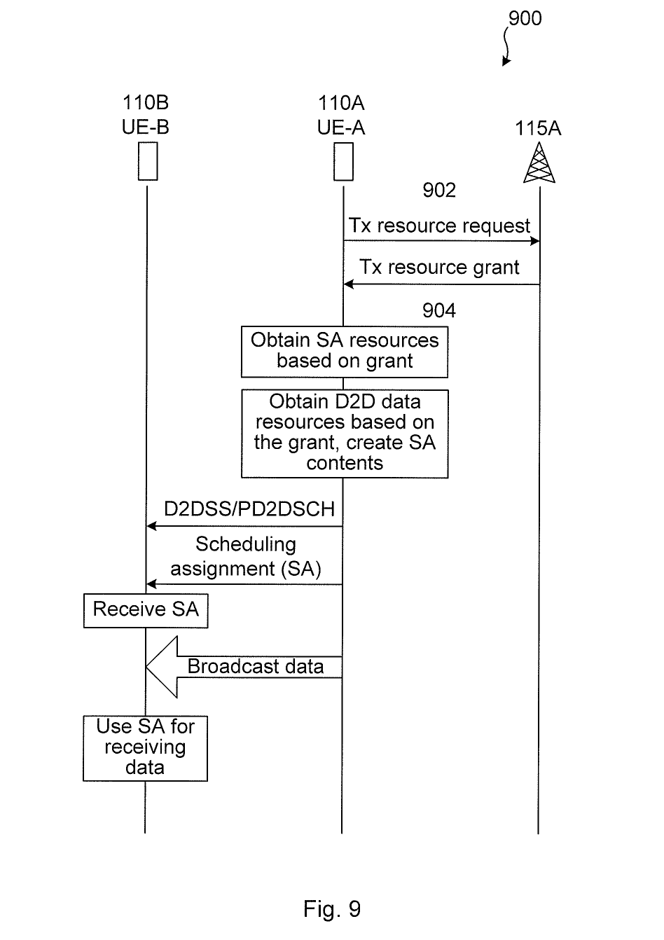

FIG. 9 is a flowchart illustrating certain embodiments of a method 900 using device-to-device frequency-related capability and configuration preferences for device-to-device communications. In certain embodiments, the steps may be performed by a first D2D-capable UE.

For example, the method may begin at step 902 when a first wireless device 110A signals its D2D frequency-related capability and/or its D2D configuration preference to a first node 115A (e.g., a network node or a second D2D-capable UE). In a particular embodiment, the capability includes one or more D2D frequency-related configurations supported by the first UE 110A. The capability and/or configuration preference may for instance be signaled before or in a request for transmission resources (such request indicated as “Tx resource request” in FIG. 9), or before a transmission resource grant in general (such grant indicated as “Tx resource grant” in FIG. 9), if a grant is sent. In other embodiments, the capability and/or configuration preference may be sent to e.g. another D2D device 110B via a direct path (not illustrated in FIG. 9). In one example, the signaling may be unicast. In another example, the signaling may be groupcast/multicast. In yet another example, the signaling may be broadcast. In yet another example, the signaling may be via higher layers (as a protocol message), lower layers (e.g. signaling a specific bit or indicator with a pre-defined meaning), physical layer or a combination thereof (e.g., part of the information via higher layers and part of the information via physical layer).

The configuration preferences of the D2D capable device 110A may be based e.g. on expected performance, interference or load sensing (e.g., a lot of activity on a certain frequency sensed by the D2D capable device 110A may result in poor performance and would thus preferably be avoided), currently used frequency or frequencies (e.g. to minimize any frequency switching impact, such as switching time and frequency retuning, or interference between the frequencies), device-specific implementation or configuration (e.g., a default setting by the manufacturer, operator, or user), quality during simultaneous operation of D2D and cellular service (e.g., if currently operating cellular service on frequency fi and/or with bandwidth BWi, it may be preferred to use frequency f2 and/or bandwidth BW2), etc.

At step 904, wireless device iioA may receive a message or indication from the first node 115A, based on the capability/preference. In a particular embodiment, the message may be used for configuring the first D2D-capable UE 110A to operate with at least one of the D2D frequency-related configurations supported/preferred by the first UE 110A. For example, the message may include a message causing the performance of one or more of the following steps:
configuring the first UE to operate on at least one of the carrier frequencies/bands/RATs supported/preferred by the UE for D2D operation, and/or
configuring the first UE to operate with a certain bandwidth for D2D operation.

In certain embodiments, the message/indication received at step 904 may also include resource allocation (resource pool or specific resources for scheduling assignment, SA, and/or data) for the at least one of the carrier frequencies/bands/RATs supported/preferred by the UE for D2D operation. The message/indication may also include an indication whether the D2D configuration on another carrier/band/RAT (supported by the UE) is the same or different than the reference configuration (e.g., serving-cell or serving carrier configuration for D2D). Additionally or alternatively, the message/indication may comprise D2D operation denial (implicit or explicit) on at least one or more of the frequencies/bands/RATs supported/preferred by the UE. In particular embodiments, the message may comprise D2D assistance data to support D2D operation, a transmission configuration (e.g., bandwidth, transmit power, frequency, contiguous/non-contiguous transmission, single or multi-carrier transmission, etc.) to be used by the first UE, a configuration of a signal/channel to be received by the first UE, and/or a reception configuration for D2D operation on a carrier other than the one via which the message/indication is received (e.g., in cross-carrier configuration or inter-frequency configuration).

In one embodiment, for example, the method goo may also comprise receiving by the first UE 110A a request for D2D-related capability(-ies) from another node 110B, before the signaling of D2D frequency-related capability to a first node 115A. In other embodiments, UE 110A may obtain SA resources prior to receiving a request from wireless device 110B.

In certain embodiments, the D2D frequency-related capability is not the same, at least in one parameter or its value, as the first-UE capability for non-D2D operation. Wireless device 110A may perform at least one D2D operation while being configured with the at least one of the D2D frequency-related configurations.

In other embodiments, a method for obtaining and using UE D2D Frequency-Related Probability and D2D configuration preferences may be performed by network node 115, radio network controller 120, or packet core network 130. For example, network node 115 may receive D2D frequency-related capability and/or its D2D configuration preference of a first D2D-capable UE 110A via one or more of:
Receiving from the first D2D-capable UE,
Receiving from a third UE,
Receiving from another network node,
The received D2D frequency-related capability and/or its D2D configuration preference may be via unicast/groupcast/multicast/broadcast (as described earlier);

The received D2D frequency-related capability and/or its D2D configuration preference may be via higher layers, lower layers or a combination thereof (as described earlier)

Network node 115 may then use the obtained capability/preference for one or more operational tasks. For example, in certain embodiments, network node 115 may perform one or more of the following steps:
Sending to the first D2D-capable UE a message or indication, based on the received capability/preference, for configuring the first D2D-capable UE to operate with at least one of the D2D frequency-related configurations supported/preferred by the first D2D-capable UE (as described earlier),
Sending to another UE or another node a message or indication, based on the received capability/preference, with configuration data for the first D2D-capable UE, the configuration data being based on the received capability/preference,
Sending or forwarding to another UE or another node the data comprising at least in part the received D2D frequency-related capability of the first D2D-capable UE,
Sending or forwarding to another UE or another node the data comprising at least in part the received D2D configuration preference of the first D2D-capable UE,
Scheduling or rescheduling or allocating or reallocating radio resources, adaptively to the received capability, a D2D operation and/or cellular operation for another UE(s),
Scheduling or rescheduling or allocating or reallocating radio resources, adaptively to the received preference, a D2D operation and/or cellular operation for another UE(s),
Scheduling or rescheduling or allocating or reallocating radio resources, adaptively to the received capability, a D2D operation and/or cellular operation for the first D2D-capable UE,
Scheduling or rescheduling or allocating or reallocating radio resources, adaptively to the received preference, a D2D operation and/or cellular operation for the first D2D-capable UE,
Storing the received capability, e.g., for statistics or using as the history information for configuring this and/or other UEs for D2D and/or cellular operation,
Storing the received D2D preferred configuration, e.g., for statistics or using as the history information or preferred configuration for this and/or other UEs.

In one embodiment, the aforementioned scheduling or rescheduling or allocation or reallocation of radio resources may comprise, e.g., changing a resource allocation pattern, scheduling configuration, configuring/changing carrier frequency, configuring the set of serving cells, configuring transmission periodicity of a UE, configuring receive bandwidth of a UE and/or configuring other receiver parameters of a UE, configuring transmit bandwidth of a UE and/or configuring transmit power and/or other transmission parameters of a UE, reserving or changing bandwidth for D2D.

### Summary of Example Implementation

Thus, in particular example implementations, the proposed solutions may provide a method for providing device-to-device communications using device-to-device frequency-related capability and configuration preferences for wireless devices.

In one example embodiment, the method may be implemented by a first D2D capable wireless device and may include:
Signaling a device-to-device frequency-related capability and/or its D2D configuration preference to a first node,
Receiving a message or indication from the first node based on the capability and/or D2D configuration preference;
Configuring the first D2D-capable wireless to operate with at least one of the D2D frequency-related configurations supported/preferred by the first wireless device;
Performing at least one D2D operation while being configured with the at least one of the D2D frequency-related configurations;
Optionally, the signaled capability comprises one or more D2D frequency-related configurations supported by the first D2D-capable wireless device;
Optionally, the first node may include a network node;
Optionally, the first node may include a second D2D-capable wireless device;

In another example embodiment, the method may be implemented by a network node and may include:
Receiving D2D frequency-related capability and/or D2D configuration preference from a first D2D-capable wireless device;
Using the obtained capability/preferences for one or more operational tasks.

Other implementations may include a wireless communication device and/or access node configured to implement the described method, or a wireless communication system in which a wireless communication device and/or access node implement the described method.

Some embodiments of the disclosure may provide one or more technical advantages. For example, certain embodiments may provide off-loading of the cellular network, faster communication, increased awareness of surrounding wireless devices of interest (e.g., running the same application), higher-quality links due to a shorter distance, etc. Some appealing applications of D2D communications are video streaming, online gaming, media downloading, peer-to-peer (P2P), file sharing, etc.

Some embodiments may benefit from some, none, or all of these advantages. Other technical advantages may be readily ascertained by one of ordinary skill in the art.

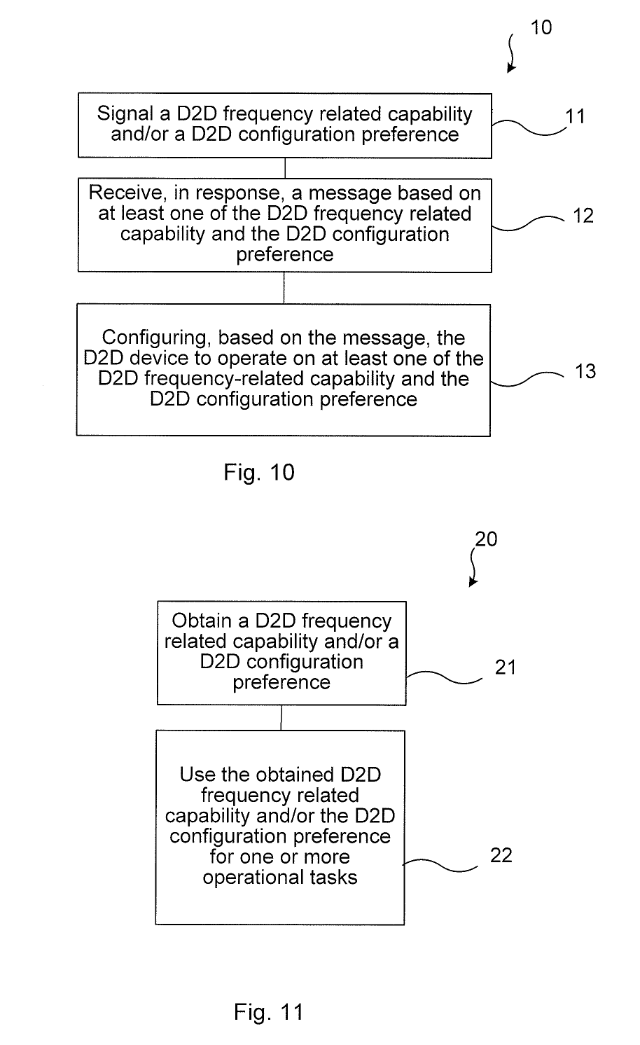

The various features and embodiments that have been described may be combined in different ways, examples of which are given in the following, with reference to FIGS. 10 and

FIG. 10 is a flow chart illustrating a method in a device-to-device, D2D, capable wireless device. The method in may be implemented for providing device-to-device, D2D, operation and may be performed in a first D2D capable wireless device 110A. The method 10 comprises signaling 11, to a first node 115A; 110B, at least one of: a D2D frequency-related capability and a D2D configuration preference of the first D2D capable wireless device 110A. The first D2D capable wireless device 110A may thus signal one or more of its capabilities related to D2D operation to a network node 115A (e.g. a base station) and/or to another D2D capable wireless device 110B. The signaling may be effectuated in different ways, e.g. unicast, multicast or broadcast to mention a few examples.

The method 10 comprises receiving 12, from the first node 115A; 110B, a message based on at least one of the D2D frequency-related capability and the D2D configuration preference. The message may be received in response to the first D2D capable wireless device 110A signaling its capabilities.

The method 10 comprises configuring 13, based on the message received from the first node 115A; 110B, the first D2D-capable wireless device 110A to operate according to at least one of the D2D frequency-related capability and the D2D configuration preference.

In an embodiment, the method 10 comprises performing at least one D2D operation while being configured with at least one of the D2D frequency-related capability and the D2D configuration preference.

In an embodiment, the D2D operation comprises one or more of: transmitting or receiving a signal and/or channel for establishing D2D communication, transmitting or receiving data by means of D2D communication, transmitting or receiving control or assistance data for D2D purpose, transmitting or receiving a request for control or assistance data for D2D, selecting a D2D operation mode, initiating D2D operation, switching to D2D operation mode from a cellular operation mode, and configuring receiver or transmitter with one or more parameters for D2D communication.

In various embodiments, the method 10 comprises receiving, prior to the signaling 11, a request for a D2D frequency-related capability from a second node 110B; 115A. The method 10 may hence be performed in response to the first D2D capable wireless device 110A receiving an inquiry from a node (e.g. a base station or another D2D capable wireless device 110B) about its capabilities.

In various embodiments, the D2D configuration preference comprises one or more of: one or more specific carrier frequencies, frequency bands, or radio access technologies; transmission and/or reception bandwidth or bandwidth combinations on a frequency carrier, or bandwidth combinations over two or more carriers; specific time and/or frequency resources; communication range for D2D communication; D2D operation on serving carrier(s) only; D2D operation on a non-serving carrier; specific duplex configuration(s); a configuration enabling a specified capacity; target quality of service, QoS, for D2D operation; spectrum type; contiguous or non-contiguous transmissions and/or reception in a frequency domain; multi-carrier D2D operation; multiplexing in frequency domain of signals and/or channels related to D2D operation with other types of signals and/or channels.

In various embodiments, the signaled D2D frequency-related capability comprises one or more D2D frequency-related configurations supported by the first D2D-capable wireless device 110A.

In various embodiments, the first node 115A; 110B comprises a network node 115A or a second D2D capable wireless device 110B.

With reference again to FIG. 2, a device-to-device, D2D, capable wireless device 110A is disclosed for providing D2D operation. The D2D capable wireless device 110A is configured to:
signal, to a first node 115A; 110B, at least one of: a D2D frequency-related capability and a D2D configuration preference of the first D2D capable wireless device 110A,
receive, from the first node 115A; 110B, a message based on at least one of the D2D frequency-related capability and the D2D configuration preference,
configure, based on the message, the first D2D capable wireless device 110A to operate according to at least one of the D2D frequency-related capability and the D2D configuration preference.

The device-to-device, D2D, capable wireless device 110A may be configured to perform the above steps e.g. by comprising a processor 220 and memory 230, the memory 230 containing instructions executable by the processor 220, whereby the device-to-device, D2D, capable wireless device 110A is operative to perform the steps.

In an embodiment, the device-to-device, D2D, capable wireless device 110A is configured to perform at least one D2D operation while being configured with at least one of the D2D frequency-related capability and the D2D configuration preference.

In various embodiments, the D2D operation comprises one or more of: transmitting or receiving a signal and/or channel for establishing D2D communication, transmitting or receiving data by means of D2D communication, transmitting or receiving control or assistance data for D2D purpose, transmitting or receiving a request for control or assistance data for D2D, selecting a D2D operation mode, initiating D2D operation, switching to D2D operation mode from a cellular operation mode, and configuring receiver or transmitter with one or more parameters for D2D communication.

In various embodiments, the device-to-device, D2D, capable wireless device 110A is configured to receive, prior to the signaling, a request for a D2D frequency-related capability from a second node 110B, 115A.

In various embodiments, the D2D configuration preference comprises one or more of: one or more specific carrier frequencies, frequency bands, or radio access technologies; transmission and/or reception bandwidth or bandwidth combinations on a frequency carrier, or bandwidth combinations over two or more carriers; specific time and/or frequency resources; communication range for D2D communication; D2D operation on serving carrier(s) only; D2D operation on a non-serving carrier; specific duplex configuration(s); a configuration enabling a specified capacity; target quality of service, QoS, for D2D operation; spectrum type; contiguous or non-contiguous transmissions and/or reception in a frequency domain; multi-carrier D2D operation; multiplexing in frequency domain of signals and/or channels related to D2D operation with other types of signals and/or channels.

In various embodiments, the signaled D2D frequency-related capability comprises one or more D2D frequency-related configurations supported by the first D2D-capable wireless device 110A.

In different embodiments, the first node 115A; 110B comprises a network node 115A or a second D2D capable wireless device 110B.

FIG. 11 is a flow chart illustrating a method in a node. The method 20 for providing device-to-device, D2D, operation may be performed in a node 115A, 110B, e.g. a base station or a wireless device, in particular a D2D capable wireless device. The method 20 comprises obtaining 21 at least one of: a D2D frequency-related capability and a D2D configuration preference of a first D2D capable wireless device 110A. The obtaining 21 of the capability and/or configuration preference may for instance be received over signaling.

The method 20 comprises using 22 the obtained D2D frequency-related capability and/or the D2D configuration preference of the first D2D capable wireless device 110A for one or more operational tasks.

In various embodiments, the at least one of the D2D frequency-related capability and the D2D configuration preference is received from one or more of: the first D2D capable wireless device 110A, a second D2D capable wireless device 110B, a second network node 115B, and higher layers, lower layers or combinations thereof.

In various embodiments, the operational task comprises one or more of: sending to the first D2D-capable device 110A a message or indication, based on the received D2D frequency-related capability and/or the D2D configuration preference, for configuring the first D2D-capable device 110A to operate with at least one of the D2D frequency-related capability and a D2D configuration preference; sending to another D2D capable wireless device 110B or another node 115B a message or indication, based on the received D2D frequency-related capability and/or the D2D configuration preference, with configuration data for the first D2D-capable device 110A, the configuration data being based on the received D2D frequency-related capability and/or the D2D configuration preference; sending or forwarding to another D2D capable wireless device 110B or another node 115B the data comprising at least in part the received D2D frequency-related capability of the first D2D-capable device 110A; sending or forwarding to another D2D capable wireless device 110B or another node 115B the data comprising at least in part the received D2D configuration preference of the first D2D-capable device 110A; scheduling, rescheduling, allocating or reallocating radio resources adaptively according to the received capability, a D2D operation and/or cellular operation for another wireless device 110B; scheduling, rescheduling, allocating or reallocating radio resources adaptively according to the received preference, a D2D operation and/or cellular operation for another wireless device 110B; scheduling, rescheduling, allocating or reallocating radio resources adaptively according to the received capability, a D2D operation and/or cellular operation for the first D2D-capable device 110A; scheduling, rescheduling, allocating or reallocating radio resources adaptively according to the received preference, a D2D operation and/or cellular operation for the first D2D-capable device 110A; storing the received capability for statistics or for use as the history information for configuring the first D2D capable wireless device 110A and/or other wireless devices 110B for D2D operation and/or cellular operation; storing the received D2D preferred configuration for statistics or for use as history information or as a preferred configuration for the first D2D capable wireless device 110A and/or other wireless devices 110B.

In other embodiments, the operational task comprises one or more of: scheduling, rescheduling, allocating or reallocating radio resources, wherein the scheduling, rescheduling, allocating or reallocating radio resources comprises changing a resource allocation pattern, scheduling configuration, configuring/changing carrier frequency, configuring a set of serving cells, configuring transmission periodicity of a wireless device 110A, 110B, configuring receive bandwidth of a wireless device 110A, 110B and/or configuring other receiver parameters of a wireless device 110A, 110B, configuring transmit bandwidth of a wireless device 110A, 110B and/or configuring transmit power and/or other transmission parameters of a wireless device 110A, 110B, reserving or changing bandwidth for D2D communication.

It is noted that the method 10 described in relation to FIG. 10 and the method described in relation to FIG. 11 may both be implemented e.g. in a D2D capable wireless device 110A, 110B. The D2D capable wireless device 110A, 110B may thereby both signal its capabilities and/or preferences to other nodes, as well as act on capability/preference signaling that it receives from and which relates to other nodes.

With reference again to FIG. 3, a node 115A, 110B is disclosed for providing device-to-device, D2D, operation. The node 115A, 110B is configured to:
obtain at least one of: a D2D frequency-related capability and a D2D configuration preference of a first D2D capable wireless device 110A, and
use the obtained D2D frequency-related capability and/or the D2D configuration preference of the first D2D capable wireless device 110A for one or more operational tasks.

The node 115, 110B may be configured to perform the above steps e.g. by comprising a processor 320 and memory 330, the memory 330 containing instructions executable by the processor 320, whereby the node 115, 110B is operative to perform the steps.

In various embodiments, the at least one of the D2D frequency-related capability and the D2D configuration preference is received from one or more of: the first D2D capable wireless device 110A, a second D2D capable wireless device 110B, a second network node 115B, and higher layers, lower layers or combinations thereof.

In various embodiments, the operational task comprises one or more of: sending to the first D2D-capable device 110A a message or indication, based on the received D2D frequency-related capability and/or the D2D configuration preference, for configuring the first D2D-capable device 110A to operate with at least one of the D2D frequency-related capability and a D2D configuration preference; sending to another D2D capable wireless device 110B or another node 115B a message or indication, based on the received D2D frequency-related capability and/or the D2D configuration preference, with configuration data for the first D2D-capable device 110A, the configuration data being based on the received D2D frequency-related capability and/or the D2D configuration preference; sending or forwarding to another D2D capable wireless device 110B or another node 115B the data comprising at least in part the received D2D frequency-related capability of the first D2D-capable device 110A; sending or forwarding to another D2D capable wireless device 110B or another node 115B the data comprising at least in part the received D2D configuration preference of the first D2D-capable device 110A; scheduling, rescheduling, allocating or reallocating radio resources adaptively according to the received capability, a D2D operation and/or cellular operation for another wireless device 110B; scheduling, rescheduling, allocating or reallocating radio resources adaptively according to the received preference, a D2D operation and/or cellular operation for another wireless device 110B; scheduling, rescheduling, allocating or reallocating radio resources adaptively according to the received capability, a D2D operation and/or cellular operation for the first D2D-capable device 110A; scheduling, rescheduling, allocating or reallocating radio resources adaptively according to the received preference, a D2D operation and/or cellular operation for the first D2D-capable device 110A; storing the received capability for statistics or for use as the history information for configuring the first D2D capable wireless device 110A and/or other wireless devices 11B for D2D operation and/or cellular operation; storing the received D2D preferred configuration for statistics or for use as history information or as a preferred configuration for the first D2D capable wireless device 110A and/or other wireless devices 110B.

In various embodiments, the operational task comprises one or more of: scheduling, rescheduling, allocating or reallocating radio resources, wherein the scheduling, rescheduling, allocating or reallocating radio resources comprises changing a resource allocation pattern, scheduling configuration, configuring/changing carrier frequency, configuring a set of serving cells, configuring transmission periodicity of a wireless device 110A, 110B, configuring receive bandwidth of a wireless device 110A, 110B and/or configuring other receiver parameters of a wireless device 110A, 110B, configuring transmit bandwidth of a wireless device 110A, 110B and/or configuring transmit power and/or other transmission parameters of a wireless device 110A, 110B, reserving or changing bandwidth for D2D communication.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

Abbreviations used in the preceding description include:
D2D Device-to-Device
D2DSS D2D synchronization signal
D2DPSCH D2D physical synchronization channel
ProSe Proximity Service

1. A method for providing device-to-device, D2D, operation performed in a first D2D capable wireless device, the method comprising:
signaling, to a first node, at least one of: a D2D frequency-related capability and a D2D configuration preference of the first D2D capable wireless device,
receiving, from the first node, a message based on at least one of the D2D frequency-related capability and the D2D configuration preference, and
configuring, based on the message received from the first node, the first D2D-capable wireless device to operate according to at least one of the D2D frequency-related capability and the D2D configuration preference.

2. The method as claimed in claim 1, comprising:
performing at least one D2D operation while being configured with at least one of the D2D frequency-related capability and the D2D configuration preference.

3. The method as claimed in claim 2, wherein the D2D operation comprises one or more of: transmitting or receiving a signal and/or channel for establishing D2D communication, transmitting or receiving data by means of D2D communication, transmitting or receiving control or assistance data for D2D purpose, transmitting or receiving a request for control or assistance data for D2D, selecting a D2D operation mode, initiating D2D operation, switching to D2D operation mode from a cellular operation mode, and configuring receiver or transmitter with one or more parameters for D2D communication.

4. The method as claimed in claim 1, comprising receiving, prior to the signaling, a request for a D2D frequency-related capability from a second node.

5. The method as claimed in claim 1, wherein the D2D configuration preference comprises one or more of: one or more specific carrier frequencies, frequency bands, or radio access technologies; transmission and/or reception bandwidth or bandwidth combinations on a frequency carrier, or bandwidth combinations over two or more carriers; specific time and/or frequency resources; communication range for D2D communication; D2D operation on serving carrier(s) only; D2D operation on a non-serving carrier; specific duplex configuration(s); a configuration enabling a specified capacity; target quality of service, QoS, for D2D operation; spectrum type; contiguous or non-contiguous transmissions and/or reception in a frequency domain; multi-carrier D2D operation; multiplexing in frequency domain of signals and/or channels related to D2D operation with other types of signals and/or channels.

6. The method as claimed in claim 1, wherein the signaled D2D frequency-related capability comprises one or more D2D frequency-related configurations supported by the first D2D-capable wireless device.

7. The method as claimed in claim 1, wherein the first node comprises a network node or a second D2D capable wireless device.

8. A computer program for a D2D capable wireless device, the computer program comprising computer program code, which, when executed on at least one processor on the D2D capable wireless device, causes the D2D capable wireless device, to perform the method according to claim 1.

9. (canceled)

10. A device-to-device, D2D, capable wireless device for providing D2D operation, the D2D capable wireless device being configured to:
signal, to a first node, at least one of: a D2D frequency-related capability and a D2D configuration preference of the first D2D capable wireless device,
receive, from the first node, a message based on at least one of the D2D frequency-related capability and the D2D configuration preference, and
configure, based on the message received from the first node, the first D2D-capable wireless device to operate according to at least one of the D2D frequency-related capability and the D2D configuration preference.

11. The device-to-device, D2D, capable wireless device as claimed in claim 10, configured to:
perform at least one D2D operation while being configured with at least one of the D2D frequency-related capability and the D2D configuration preference.

12. The device-to-device, D2D, capable wireless device (110A) as claimed in claim 11, wherein the D2D operation comprises one or more of: transmitting or receiving a signal and/or channel for establishing D2D communication, transmitting or receiving data by means of D2D communication, transmitting or receiving control or assistance data for D2D purpose, transmitting or receiving a request for control or assistance data for D2D, selecting a D2D operation mode, initiating D2D operation, switching to D2D operation mode from a cellular operation mode, and configuring receiver or transmitter with one or more parameters for D2D communication.

13. The device-to-device, D2D, capable wireless device as claimed in claim 10, configure to receive, prior to the signaling, a request for a D2D frequency-related capability from a second node.

14. The device-to-device, D2D, capable wireless device as claimed in claim 10, wherein the D2D configuration preference comprises one or more of: one or more specific carrier frequencies, frequency bands, or radio access technologies; transmission and/or reception bandwidth or bandwidth combinations on a frequency carrier, or bandwidth combinations over two or more carriers; specific time and/or frequency resources; communication range for D2D communication; D2D operation on serving carrier(s) only; D2D operation on a non-serving carrier; specific duplex configuration(s); a configuration enabling a specified capacity; target quality of service, QoS, for D2D operation; spectrum type; contiguous or non-contiguous transmissions and/or reception in a frequency domain; multi-carrier D2D operation; multiplexing in frequency domain of signals and/or channels related to D2D operation with other types of signals and/or channels.

15. The device-to-device, D2D, capable wireless device as claimed in claim 10, wherein the signaled D2D frequency-related capability comprises one or more D2D frequency-related configurations supported by the first D2D-capable wireless device.

16. The device-to-device, D2D, capable wireless device as claimed in claim 10, wherein the first node comprises a network node or a second D2D capable wireless device.

17. A method for providing device-to-device, D2D, operation performed in a node, the method comprising:
obtaining at least one of: a D2D frequency-related capability and a D2D configuration preference of a first D2D capable wireless device, and
using the obtained D2D frequency-related capability and/or the D2D configuration preference of the first D2D capable wireless device for one or more operational tasks.

18. The method as claimed in claim 17, wherein the at least one of the D2D frequency-related capability and the D2D configuration preference is received from one or more of: the first D2D capable wireless device, a second D2D capable wireless device, a second network node, and higher layers, lower layers or combinations thereof.

19. The method as claimed in claim 17, wherein the operational task comprises one or more of: sending to the first D2D-capable device a message or indication, based on the received D2D frequency-related capability and/or the D2D configuration preference, for configuring the first D2D-capable device to operate with at least one of the D2D frequency-related capability and a D2D configuration preference; sending to another D2D capable wireless device or another node a message or indication, based on the received D2D frequency-related capability and/or the D2D configuration preference, with configuration data for the first D2D-capable device, the configuration data being based on the received D2D frequency-related capability and/or the D2D configuration preference; sending or forwarding to another D2D capable wireless device or another node the data comprising at least in part the received D2D frequency-related capability of the first D2D-capable device; sending or forwarding to another D2D capable wireless device or another node the data comprising at least in part the received D2D configuration preference of the first D2D-capable device; scheduling, rescheduling, allocating or reallocating radio resources adaptively according to the received capability, a D2D operation and/or cellular operation for another wireless device; scheduling, rescheduling, allocating or reallocating radio resources adaptively according to the received preference, a D2D operation and/or cellular operation for another wireless device; scheduling, rescheduling, allocating or reallocating radio resources adaptively according to the received capability, a D2D operation and/or cellular operation for the first D2D-capable device; scheduling, rescheduling, allocating or reallocating radio resources adaptively according to the received preference, a D2D operation and/or cellular operation for the first D2D-capable device; storing the received capability for statistics or for use as the history information for configuring the first D2D capable wireless device and/or other wireless devices for D2D operation and/or cellular operation; storing the received D2D preferred configuration for statistics or for use as history information or as a preferred configuration for the first D2D capable wireless device and/or other wireless devices.

20. The method as claimed in claim 17 or 18, wherein the operational task comprises one or more of: scheduling, rescheduling, allocating or reallocating radio resources, wherein the scheduling, rescheduling, allocating or reallocating radio resources comprises changing a resource allocation pattern, scheduling configuration, configuring/changing carrier frequency, configuring a set of serving cells, configuring transmission periodicity of a wireless device, configuring receive bandwidth of a wireless device and/or configuring other receiver parameters of a wireless device, configuring transmit bandwidth of a wireless device and/or configuring transmit power and/or other transmission parameters of a wireless device, reserving or changing bandwidth for D2D communication.

21. A computer program for a node, the computer program comprising computer program code, which, when executed on at least one processor on the node, causes the node to perform the method according to claim 17.

22. (canceled)

23. A node for providing device-to-device, D2D, operation, the node being configured to:
obtain at least one of: a D2D frequency-related capability and a D2D configuration preference of a first D2D capable wireless device, and
use the obtained D2D frequency-related capability and/or the D2D configuration preference of the first D2D capable wireless device for one or more operational tasks.

24. The node as claimed in claim 23, wherein the at least one of the D2D frequency-related capability and the D2D configuration preference is received from one or more of: the first D2D capable wireless device, a second D2D capable wireless device, a second network node, and higher layers, lower layers or combinations thereof.

25. The node as claimed in claim 23 or 24, wherein the operational task comprises one or more of: sending to the first D2D-capable device a message or indication, based on the received D2D frequency-related capability and/or the D2D configuration preference, for configuring the first D2D-capable device to operate with at least one of the D2D frequency-related capability and a D2D configuration preference; sending to another D2D capable wireless device or another node a message or indication, based on the received D2D frequency-related capability and/or the D2D configuration preference, with configuration data for the first D2D-capable device, the configuration data being based on the received D2D frequency-related capability and/or the D2D configuration preference; sending or forwarding to another D2D capable wireless device or another node the data comprising at least in part the received D2D frequency-related capability of the first D2D-capable device; sending or forwarding to another D2D capable wireless device or another node the data comprising at least in part the received D2D configuration preference of the first D2D-capable device; scheduling, rescheduling, allocating or reallocating radio resources adaptively according to the received capability, a D2D operation and/or cellular operation for another wireless device; scheduling, rescheduling, allocating or reallocating radio resources adaptively according to the received preference, a D2D operation and/or cellular operation for another wireless device; scheduling, rescheduling, allocating or reallocating radio resources adaptively according to the received capability, a D2D operation and/or cellular operation for the first D2D-capable device; scheduling, rescheduling, allocating or reallocating radio resources adaptively according to the received preference, a D2D operation and/or cellular operation for the first D2D-capable device; storing the received capability for statistics or for use as the history information for configuring the first D2D capable wireless device and/or other wireless devices for D2D operation and/or cellular operation; storing the received D2D preferred configuration for statistics or for use as history information or as a preferred configuration for the first D2D capable wireless device and/or other wireless devices.

26. The node as claimed in claim 23, wherein the operational task comprises one or more of: scheduling, rescheduling, allocating or reallocating radio resources, wherein the scheduling, rescheduling, allocating or reallocating radio resources comprises changing a resource allocation pattern, scheduling configuration, configuring/changing carrier frequency, configuring a set of serving cells, configuring transmission periodicity of a wireless device, configuring receive bandwidth of a wireless device and/or configuring other receiver parameters of a wireless device, configuring transmit bandwidth of a wireless device and/or configuring transmit power and/or other transmission parameters of a wireless device, reserving or changing bandwidth for D2D communication.
